(19) United States
(12) Patent Application Publication
(10) Pub. No.: US 2015/0085225 A1
(43) Pub. Date: Mar. 26, 2015

(54) LED BACKLIGHT UNIT AND LED DISPLAY DEVICE INCLUDING THE SAME

(71) Applicant: Seoul Semiconductor Co., Ltd., Ansan-si (KR)

(72) Inventor: Chung Hoon LEE, Ansan-si (KR)

(21) Appl. No.: 14/556,230

(22) Filed: Nov. 30, 2014

Related U.S. Application Data
(63) Continuation of application No. PCT/KR2013/004697, filed on May 29, 2013.

(30) Foreign Application Priority Data
May 29, 2012 (KR) 10-2012-0056937

(51) Int. Cl. G02F 1/1335

(52) U.S. Cl. CPC G02F 1/133608; G02F 1/133603
USPC 349/69; 362/97.3

(57) ABSTRACT

A light emitting diode (LED) backlight unit includes: a top cover; a bottom cover connected to the top cover to constitute a housing and spaced apart under a liquid crystal panel; LEDs disposed on a first surface defined by an inner top surface of the bottom cover; and electrode patterns arranged on the first surface.

### CROSS-REFERENCE TO RELATED APPLICATIONS

This application is a continuation of International Application PCT/KR2013/004697, filed on May 29, 2013, and claims priority from and the benefit of Korean Patent Application No. 10-2012-0056937, filed on May 29, 2012, which are incorporated by reference for all purposes as if fully set forth herein.

### BACKGROUND

1. Field

Exemplary embodiments of the present invention relate to a light-emitting diode (LED) display device and an LED backlight unit having a structure suitable for the LED display device.

2. Discussion of the Background

Existing televisions using a cathode ray tube have been replaced with LED display devices. Recently, slim flat LED display devices employing an LED backlight unit have attracted attention. For example, the LED display device includes a bottom cover directly under a liquid crystal panel as a display panel. An LED backlight unit is installed inside the bottom cover facing the liquid crystal panel. The LED backlight unit includes a printed circuit board and an array of LEDs mounted on the printed circuit board.

The LED backlight unit includes a light guide plate or a diffusion plate between the liquid crystal panel and the LEDs so as to uniformly distribute light emitted from the LEDs. As the printed circuit board, a metal-core printed circuit board (MCPCB) capable of rapidly dissipating heat generated from LEDs is widely used. In addition, light diffusion lenses are used for obtaining a wide viewing angle characteristic with a small number of LEDs. The light diffusion lenses are connected on the MCPCB in correspondence to the respective LEDs.

A general LED display device may have the following problems.

First, the general LED display device may additionally requires separate light diffusion lenses so as to efficiently utilize a small number of LEDs.

Second, the general LED display device may need to employ an expensive MCPCB so as to efficiently dissipating heat generated from LEDs, resulting in an increase in manufacturing costs.

Third, the general LED display device may have a limitation in distance design between LEDs and a liquid crystal panel due to a thickness of an MCPCB. The increase in the distance between the LEDs and the liquid crystal panel may increase an area of a region of the liquid crystal panel illuminated by each LED. This can decrease the number of the LEDs, but increases the thickness of the LED display device.

The above information disclosed in this Background section is only for enhancement of understanding of the background of the invention and therefore it may contain information that does not form any part of the prior art nor what the prior art may suggest to a person of ordinary skill in the art.

### SUMMARY

Exemplary embodiments of the present invention provide an LED display device capable of being implemented with a slim profile, efficiently dissipating heat, and reducing manufacturing costs.

Additional features of the inventive concept will be set forth in the description which follows, and in part will be apparent from the description, or may be learned by practice of the inventive concept.

An exemplary embodiment of the present invention discloses an LED backlight unit including: a top cover; a bottom cover connected to the top cover to constitute a housing and spaced apart under a liquid crystal panel; and LEDs disposed on a first surface defined by an inner top surface of the bottom cover, wherein electrode patterns electrically connected to the LEDs are formed on the first surface.

Each of the LEDs may include an LED chip, and the electrode patterns include electrode patterns on which the LED chip is directly mounted.

The bottom cover may be made of a metal material and be electrically insulated from the electrode patterns by an electrical insulating layer.

The bottom cover may be made of a resin material, including a carbon nanotube (CNT) or carbon, for the purpose of heat dissipation.

The bottom cover may be made of a resin material and include a metal layer on an externally exposed surface for the purpose of heat dissipation.

The bottom cover may include a concave section to receive at least a part of the liquid crystal panel and the LEDs.

The bottom cover may include: a plate-shaped mounting portion on which the LEDs are disposed; and a support portion including an opening or window connected to the mounting portion.

An engagement or connection structure for connection of the support portion and the mounting portion may be formed in an edge of the mounting portion and an inner side of the opening.

The mounting portion may include a plurality of mounting plates assembled with each other.

An exemplary embodiment of the present invention discloses an LED backlight unit including: a top cover; a bottom cover connected to the top cover to constitute a housing and spaced apart under a liquid crystal panel; and chip-level LEDs disposed on a first surface defined by an inner top surface of the bottom cover, wherein molding portions are formed on the first surface to cover the LEDs, respectively.

Each of the molding portions may include: a first molding portion formed to directly cover the LED; and a second molding portion formed on the first molding portion.

A refractive index of the first molding portion may be different from a refractive index of the second molding portion.

Each of the molding portions may include a medium layer between the first molding portion and the second molding portion, a refractive index of the medium layer being smaller than a refractive index of the first molding portion and a refractive index of the second molding portion.

The medium layer may include an air gap.

The molding portion may include a concave section in a center of a top surface.

A plane shape of the molding portion may be any one of an axially symmetric shape, a 90-degree rotationally symmetric shape, and a 180-degree rotationally symmetric shape with respect to a central axis line of the molding portion.

Electrode patterns electrically connected to the LEDs may be formed on the first surface.

The molding portion may be formed to have a shape different from the resin material by semi-curing a resin material primarily molded in advance and pressurizing the primarily molded resin material.

The molding portion is comprised to expand the light of LED.

An exemplary embodiment of the present invention also discloses an LED display device including: the top cover having an opening or window; the bottom cover connected to the top cover to constitute a single box-shaped housing; and the liquid crystal panel spaced apart from the first surface within the housing and exposed through the opening or window.

According to exemplary embodiments of the present invention, the manufacturing cost can be significantly reduced by removing an MCPCB included in a general LED backlight unit, and heat dissipation characteristic of the LED display device and the LED backlight unit used therein can be remarkably improved. Moreover, the number of LEDs can be minimized and the LED display device can be implemented with the slim profile.

It is to be understood that both the foregoing general description and the following detailed description are exemplary and explanatory and are intended to provide further explanation of the invention as claimed.

### BRIEF DESCRIPTION OF THE DRAWINGS

FIG. 1 is an exploded perspective view illustrating an LED display device according to an exemplary embodiment of the present invention.

FIG. 2 is a cross-sectional view illustrating an LED backlight unit of the LED display device of FIG. 1.

FIG. 3 is a cross-sectional view for describing an LED backlight unit of an LED display device according to an exemplary embodiment of the present invention.

FIG. 4 is a cross-sectional view for describing an LED backlight unit of an LED display device according to an exemplary embodiment of the present invention.

FIG. 5 is a cross-sectional view for describing an LED backlight unit of an LED display device according to an exemplary embodiment of the present invention.

FIGS. 6(a), 6(b), and 6(c) are top views for describing various plane shapes of a molding portion, which can be applied to the exemplary embodiments of the present invention.

FIG. 7 is a cross-sectional view for describing a molding portion according to an exemplary embodiment of the present invention.

FIG. 8 is a cross-sectional view for describing a molding portion according to an exemplary embodiment of the present invention.

FIG. 9 is a cross-sectional view for describing a molding portion according to an exemplary embodiment of the present invention.

FIG. 10 is a cross-sectional view for describing a molding portion according to an exemplary embodiment of the present invention.

### DETAILED DESCRIPTION OF THE ILLUSTRATED EMBODIMENTS

Exemplary embodiments of the present invention will be described below in detail with reference to the accompanying drawings. These exemplary embodiments are provided so that this disclosure will be thorough and complete, and will fully convey the scope of the invention to those skilled in the art. The present invention may, however, be embodied in many different forms and should not be construed as being limited to the exemplary embodiments set forth herein. In the drawings, the widths, lengths and thicknesses of elements may be exaggerated for clarity. Throughout the drawings and description, like reference numerals will be used to refer to like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

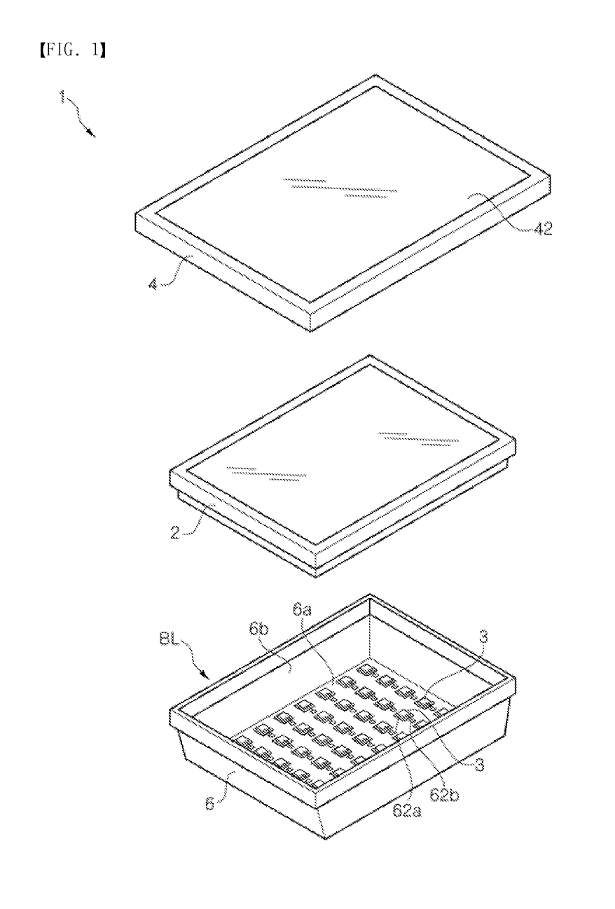

FIG. 1 is an exploded perspective view illustrating an LED display device 1 according to an exemplary embodiment of the present invention, and FIG. 2 is a cross-sectional view illustrating an LED backlight unit of the LED display device 1 of FIG. 1.

The LED display device 1 according to the present exemplary embodiment includes a rectangular liquid crystal panel 2, a box-shaped top cover 4, and a box-shaped bottom cover 6. The liquid crystal panel 2 is received in a housing. When it is received in the housing, the liquid crystal panel 2 is spaced apart from a first surface 6a of the bottom cover 6 by a predetermined distance. Herein, the first surface 6a is defined by an inner top surface of the bottom cover 6. In addition, the LED display device 1 includes a backlight unit BL in which a plurality of LEDs 3 are arranged in a matrix form so as to provide light to the liquid crystal panel 2.

The bottom cover 6 is formed in a concave container structure. The bottom cover 6 includes the first surface 6a that has a rectangular flat shape and is defined by the inner top surface, and second surfaces 6b that are defined by four sides extending from four edges of the first surface 6a. The liquid crystal panel 2 may be spaced apart from the first surface 6a, which is disposed on an inner bottom of the bottom cover 6, by a predetermined distance, in such a manner that the edges of the liquid crystal panel 2 are mounted on protrusions formed in the second surfaces 6a of the bottom cover 6. The top cover 4 includes a rectangular opening or light transmission window 42 exposing the liquid crystal panel 2 upwards. The top cover 4 may be disposed to substantially closely contact the liquid crystal panel 2.

Although not illustrated, an optical member, such as a diffusion plate or a light guide plate, may be further installed between the LEDs 3 and the liquid crystal panel 2.

Referring to FIGS. 1 and 2, the backlight unit BL includes the bottom covers 6 and the LEDs 3 mounted on the first surface 6a of the bottom cover 6. A plurality of electrode patterns 62a and 62b are formed on the first surface 6a of the bottom cover 6, and are electrically connected to the LEDs 3 to supply external power to the LEDs 3. The electrode patterns 62a and 62b include first electrode patterns 62a connected to first electrodes (not illustrated) of the respective LEDs 3, and second electrode patterns 62b connected to second electrodes (not illustrated) having a polarity different from that of the first electrodes.

In the present exemplary embodiment, when a package structure including lead frames or lead terminals is omitted, LED chips mounted directly on the first surface 6a of the bottom cover 6 may be used as the above-described LEDs 3. The LED chips 3 may also be directly mounted on the first electrode patterns 62a, respectively. The second electrodes of the respective LED chips 3 are electrically connected to the second electrode patterns 62b by bonding wires. When the LED chips 3 have a vertical structure having the first electrodes on the bottom thereof, the first electrodes of the LED chips 3 may be electrically connected to the first electrode patterns 62a only if the LED chips 3 are mounted on the first electrode patterns 62a. When the LED chips 3 have a horizontal or mesa structure having all the first and second electrodes on the top thereof, the first electrodes of the LED chips 3 may be electrically connected to the first electrode patterns 62a by different bonding wires. In addition, when the LED chips 3 have a flip-chip structure having all the counter electrodes of opposite polarities on one side thereof, the counter electrodes of the LED chips 3 may be directly flip-chip bonded to the first and second electrode patterns 62a and 62b of the bottom cover 6, without a sub-mount. When the LED chips are mounted on the sub-mount, a distance design between the LED chips 3 and the liquid crystal panel 2 is limited by the thickness of the sub-mount. Therefore, as described above, the LED chips 3 may be directly mounted on the first surface 6a of the bottom cover 6, without the sub-mount.

Different from the exemplary embodiment illustrated in FIGS. 1 and 2, LEDs of a package structure including lead terminals or lead frames (that is, an LED package) may be employed as the above-described LEDs 3. The lead terminals or lead frames having different polarities may be additionally used for electric connection between the first and second electrodes and the first and second electrode patterns 62a and 62b of the LED chips inside the LED package.

The bottom cover 6 may be made of a resin material or a metal. When the bottom cover 6 is made of a resin material having electrical insulating properties, the first and second electrode patterns 62a and 62b may be directly formed thereon. However, when the bottom cover 6 is made of a metal having electrically conductive properties, a separate electrical insulating film or electrical insulating layer may be formed between metal portions of the bottom cover 6 and the electrode patterns 62a and 62b.

In addition, when the bottom cover 6 is made of a resin material, a metal layer having excellent heat conductivity may be formed on surfaces exposed to the outside of the display device or the housing among the surfaces of the bottom cover 6 by using, for example, a plating method, and the metal layer may be used as a heat sink. Carbon or carbon nanotubes (CNT) having excellent heat conductivity may be mixed within the resin material used to form the bottom cover 6. The above-described top cover 4 may be made of the same material as that of the bottom cover 6, or may be made of a material different from that of the bottom cover 6.

According to the present exemplary embodiment, a metal-core PCB (MCPCB) provided in the backlight unit of the conventional LED display device is omitted, leading to a reduction in manufacturing costs. In addition, the LED display device may be made slim, and simultaneously, a distance D between the LEDs 3 and the liquid crystal panel 2 may be increased. Therefore, light emitted from the LEDs 3 can be widely illuminated on the liquid crystal panel 2. Moreover, the bottom cover 6 functions as a PCB on which the LEDs 3 are mounted, and is also directly exposed to the outside. Therefore, heat dissipation of the LED display device may be improved.

It is suitable to form the first surface 6a of the bottom cover 6 with a reflective surface having a reflective color, such as a white color, an ivory white color, or a silver color. For this purpose, a reflection film or reflection layer may be provided on the first surface 6a of the bottom cover 6.

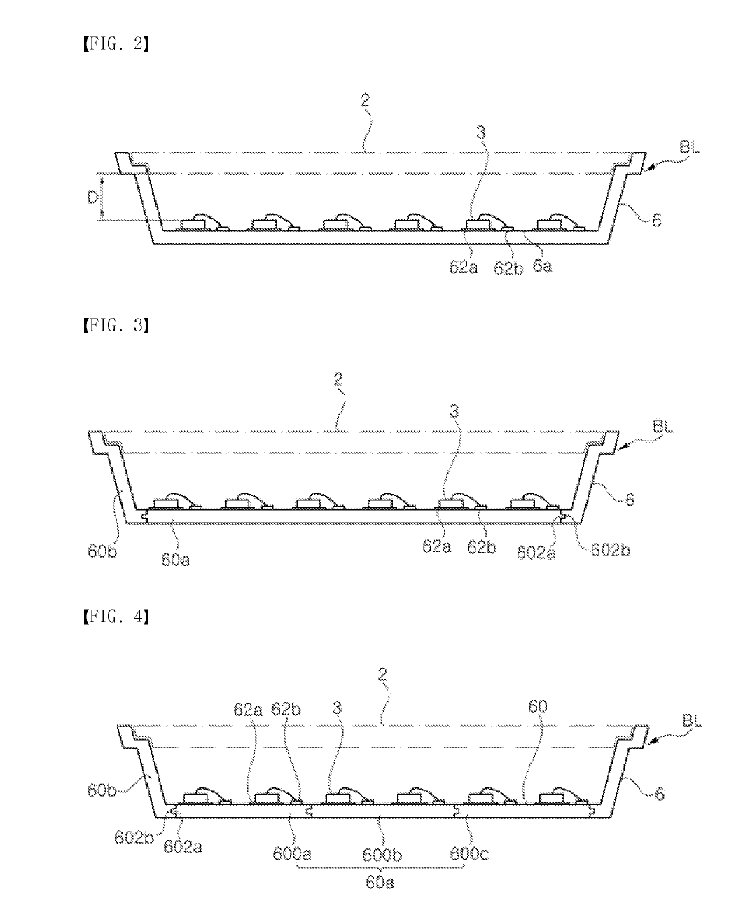

FIG. 3 is a cross-sectional view for describing an LED backlight unit of an LED display device according to an exemplary embodiment of the present invention.

Referring to FIG. 3, a bottom cover 6 has a structure that includes a plate-shaped mounting portion 60a, a convex support portion 60b with which the mounting portion 60a is assembled and supported. The support portion 60b includes an opening passing through a predetermined region including the center of the bottom. The mounting portion 60a is fitted into the opening and connected to the support portion 60b. First and second engagement portions 602a and 602b engaged with each other are formed on the edges of the mounting portion 60a and the inner surfaces of the opening of the support portion 60b. As illustrated in FIG. 3, the first and second engagement portions 602a and 602b may include protrusions, and recesses fitted into the protrusions. The engagement and disengagement between the first engagement portion 602a and the second engagement portion 602b may accommodate elastic deformation of the LED backlight unit and LED display device. Instead of or in addition to the engagement connection as illustrated in FIG. 3, a screw connection may be used to connect the mounting portion 60a and the support portion 60b.

In the present exemplary embodiment, the electrode patterns 62a and 62b as described in the foregoing exemplary embodiment described with respect to FIGS. 1 and 2 may be formed on the top surface of the mounting portion 60a. A metal layer may be formed on an externally exposed surface of the mounting portion 60a by using, for example, plating so as to improve heat dissipation performance. In addition, the LEDs 3 may be mounted on the top surface of the mounting portion 60a as described in the foregoing exemplary embodiment, and the electrodes of the LEDs 3 may be electrically connected to the electrode patterns 62a and 62b in the same method as described in the foregoing exemplary embodiment.

FIG. 4 is a cross-sectional view for describing an LED backlight unit of an LED display device according to another embodiment of the present invention.

Generally, as the size of the LED display device, in which a diagonal length of a display unit is expressed in units of inches, is increased, the size of the bottom cover 6 is also increased. This may make it difficult to manufacture the bottom cover 6 to have a PCB function. FIG. 3 illustrates an exemplary embodiment of the LED backlight unit that may be used in a large-sized LED display device. A plurality of mounting plates 600a, 600b and 600c are assembled to constitute a single mounting portion 60a. Like the above-described exemplary embodiment, the mounting portion 60a is connected to the support portion 60b of the bottom cover 6. The mounting plates 600a and 600c, which are disposed at the outermost positions of the mounting plates of the mounting portion 60a, are connected to the inner surface of the opening of the support portion 60b by engagement between the first engagement portions 602a and the second engagement portions 602b. For example, engagement portions including protrusions and recesses, which can be engaged with each other, may also be formed between the adjacent mounting plates 600a and 600b or 600b and 600c.

One or more LEDs 3 are mounted on each of the mounting plates 600a, 600b and 600c. Electrode patterns 62a and 62b, which can be electrically connected to the corresponding LEDs 3, are formed on each of the mounting plates 600a, 600b and 600c. The LEDs 3 may be directly mounted on some of the electrode patterns. The electrode patterns on the adjacent mounting plates 600a and 600b or 600b and 600c or the LEDs on the adjacent mounting plates 600a and 600b or 600b and 600c may be electrically connected together. For such electrical connection, interconnections such as bonding wires may be used, or an electric connector structure may be used.

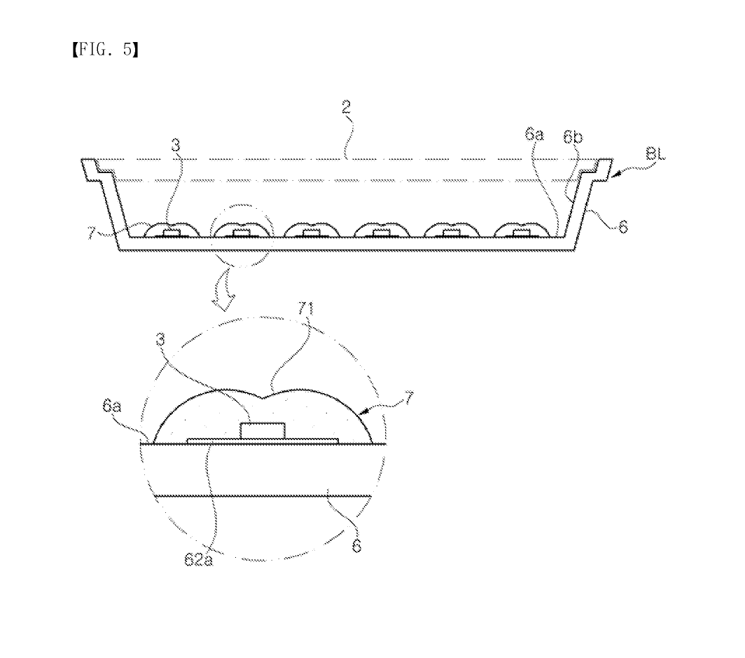

FIG. 5 is a cross-sectional view for describing an LED backlight unit of an LED display device according to an exemplary embodiment of the present invention.

Referring to FIG. 5, the LED backlight unit according to the present exemplary embodiment further includes a plurality of molding portions 7 formed on the first surface 6a of the bottom cover 6 so as to replace a conventional light diffusion lens. The molding portion 7 is suitable for a chip-on-board type in which LED chips are used as LEDs to be mounted on the first surface 6a of the bottom cover 6. The plurality of molding portions 7 are applied so as to widely distribute light while using a smaller number of LEDs. Therefore, each of the molding portions 7 has a form of a light diffusion lens. In the present exemplary embodiment, the molding portion 7 has a concave section 71 on the top surface thereof or in the center of a light emission surface. The concave section 71 disposed in the center of the light emission surface functions to widen a viewing angle. The molding portion 7 reduces an amount of light emitted outward from a side close to a central axis or optical axis, increases an amount of light in a side far from a central axis or optical axis, and diffuses light more widely. The molding portion 7 may be formed by a molding using a mold, for example, a transfer molding. In addition, the molding portion 7 may be made of a light transmissive material, in particular, silicon or epoxy resin.

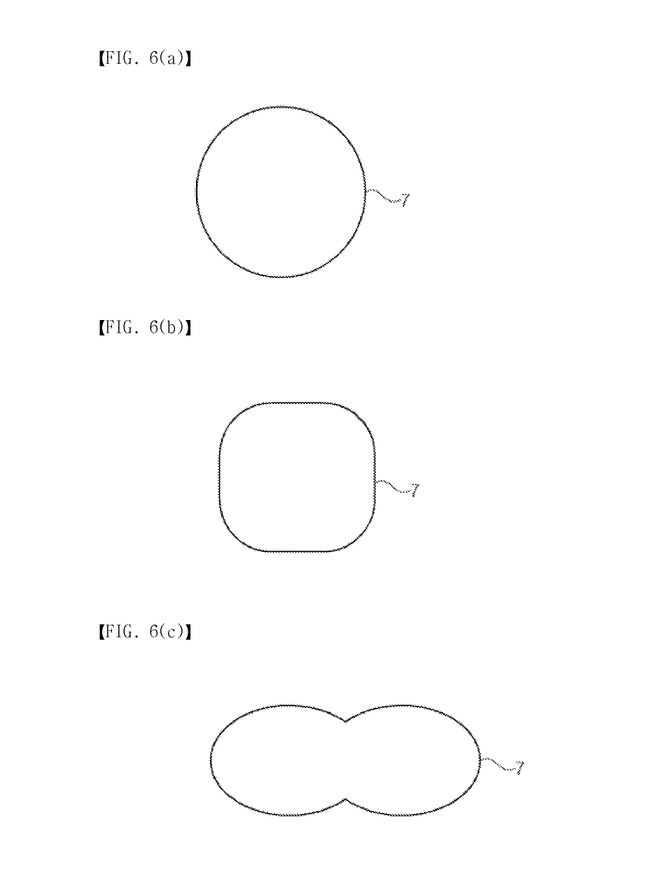

The molding portion 7 having various plane shapes may be selected. In addition to the molding portion 7 (see FIG. 6(a)) having a circular plane shape that is axially symmetric to the central axis, the molding 7 having a shape that is 90-degree rotationally symmetric to the central axis as illustrated in FIG. 6(b) may be selected, or the molding 7 having a shape that is 180-degree rotationally symmetric to the central axis as illustrated in FIG. 6(c) may be selected. When the LEDs are arrayed in rows and columns, the molding portions as illustrated in FIGS. 6(b) and 6(c) can implement a uniform illuminance distribution by overlapping of the central light pattern and the adjacent light patterns in an approximately rectangular shape.

FIG. 7 is a cross-sectional view for describing a molding portion 7 according to an exemplary embodiment of the present invention. Referring to FIG. 7, the molding portion 7 may include a first molding portion 7a formed to directly cover a chip-level LED, that is, an LED chip 3, and a second molding portion 7b formed to cover the first molding portion 7a. In the present exemplary embodiment, the first molding portion 7a and the second molding portion 7b are all formed in a lens shape including a concave section formed in the center of the top surface for the purpose of light diffusion. The lens shape of the first molding portion 7a and the second molding portion 7b can increase light diffusion toward the outer side of the above-described concave section. In this case, a refractive index of the first molding portion 7a may be smaller than a refractive index of the second molding portion 7b.

In addition, the first molding portion 7a and the second molding portion 7b are all made of a silicon resin. A refractive index of the silicon resin constituting the first molding portion 7a may be different from a refractive index of the silicon resin constituting the second molding portion 7b.

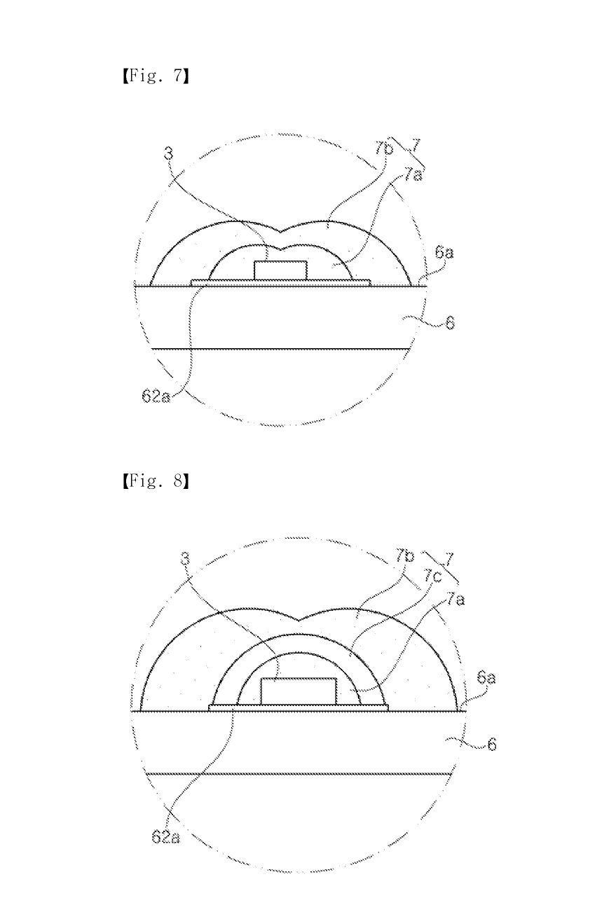

FIG. 8 is a cross-sectional view for describing a molding portion 7 according to an exemplary embodiment of the present invention. Referring to FIG. 8, the molding portion 7 may include a first molding portion 7a and a second molding portion 7b. An air gap 7c is interposed between the first molding portion 7a and the second molding portion 7b. A refractive index of the air gap 7c is smaller than a refractive index of the first and second molding portions 7a and 7b. In the present exemplary embodiment, the first molding portion 7a is formed by coating a liquid-phase or gel-phase resin, in particular, a silicon resin, on a circumferential surface of the bottom cover 6, and the second molding portion 7b is formed by a molding using a mold, that is, a transfer molding. For easy description and understanding, an element 7a, which is formed by a resin coating instead of a molding process using a mold, is also referred to as the molding portion.

In the present exemplary embodiment, the first molding portion 7a can increase light extraction efficiency by a difference in refractive index between the LED chip 3 and air. The refractive index of air is about 1.0, and the refractive index of the LED chip 3 is about 2.4. In the present exemplary embodiment, since the LED chip 3 and the first molding portion 7a functions as a single light source, a medium layer having a refractive index smaller than that of the first molding portion 7a and the second molding portion 7b may be formed between the first molding portion 7a constituting a part of the light source and the second molding portion 7b disposed thereon, so as to increase light extraction efficiency and light diffusion. In the present exemplary embodiment, the air gap 7c is used as the medium layer.

In addition, the first molding portion 7a of the present implementation example has an approximately semicircular cross-sectional shape or a hemispherical shape having no concave section in the center of the top surface. However, it should be noted that the first molding portion 7a, as in the example illustrated in FIG. 7, may be formed to have a shape with the concave section in the center of the top surface so as to further increase light diffusion.

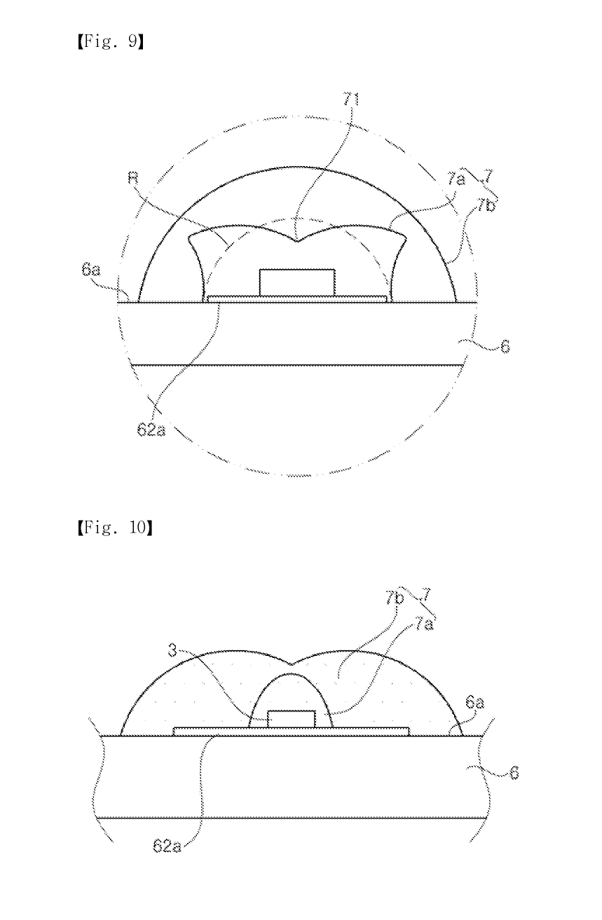

FIG. 9 is a cross-sectional view for describing a molding portion 7 according to an exemplary embodiment of the present invention. Referring to FIG. 9, like the foregoing embodiment, the molding portion 7 includes a first molding portion 7a and a second molding portion 7b. The first molding portion 7a has a concave section 71 in the center of the top surface. The shape of the first molding portion 7a having the concave section 71 can be obtained by molding a resin material R in a primary shape of an approximate hemisphere as indicated by a broken line, semi-curing (or softening) the molded resin material R with a predetermined light source or heat source, shaping the concave section 71 by pressurizing the resin material R with a predetermined reshaping mold, and completing the curing.

FIG. 10 is a cross-sectional view for describing a molding portion 7 according to an exemplary embodiment of the present invention. Referring to FIG. 10, like the foregoing embodiment, the molding portion 7 includes a first molding portion 7a and a second molding portion 7b. In the present exemplary embodiment, the first molding portion 7a and the second molding portion 7b have different refractive indexes so as to form an interface capable of changing a traveling direction of light even inside the molding portion 7. In the present exemplary embodiment, the interface between the first molding portion 7a and the second molding portion 7b, that is, a light entrance surface of the second molding portion 7b, has a bell-shaped cross-section. In the present exemplary embodiment, the light entrance surface forms an axially symmetric shape with respect to a central axis line of the molding portion 7 and thus has a bell shape as a whole. As described above, when the light entrance surface of the second molding portion 7b has the bell shape, light can be diffused more widely by setting the refractive index of the first molding portion 7a to be smaller than the refractive index of the second molding portion 7b.

While the exemplary embodiments of the present invention have been described with reference to the specific exemplary embodiments, it will be apparent to those skilled in the art that various changes and modifications may be made without departing from the spirit and scope of the inventive concept as defined in the following claims.

What is claimed is:

1. A light-emitting diode (LED) backlight unit, comprising:
a housing comprising:
a top cover; and
a bottom cover connected to the top cover, the housing being spaced apart from and disposed under a liquid crystal panel;
LEDs disposed on a first surface of the bottom cover; and
electrode patterns respectively connected to the LEDs and disposed on the first surface of the bottom cover.

2. The LED backlight unit of claim 1, wherein:
each LED comprises an LED chip; and
the LED chip is directly mounted on one of the electrode patterns.

3. The LED backlight unit of claim 1, wherein:
the bottom cover comprises a metal material; and
an insulation layer is disposed between the bottom cover and the electrode patterns.

4. The LED backlight unit of claim 1, wherein the bottom cover comprises a resin material having carbon nanotubes (CNT) or carbon disposed therein.

5. The LED backlight unit of claim 1, wherein:
the bottom cover comprises a resin material and a metal layer; and
the metal layer is disposed on an outside surface of the bottom cover.

6. The LED backlight unit of claim 1, wherein the bottom cover comprises a concave section configured to receive at least a portion of the liquid crystal panel and the LEDs.

7. The LED backlight unit of claim 1, wherein the bottom cover comprises a mounting portion and a support portion,
wherein:
the mounting portion has a plate-shape;
the LEDs are disposed on the mounting portion; and
a support portion comprising an opening or window is connected to the mounting portion.

8. The LED backlight unit of claim 7, further comprising an engagement or connection structure is disposed at an edge of the mounting portion and on an inner side of the opening,
wherein the engagement or connection structure is configured to connect the support portion and the mounting portion.

9. The LED backlight unit of claim 7, wherein the mounting portion comprises mounting plates connected with each other.

10. A light-emitting diode (LED) backlight unit, comprising:
a housing, comprising:
a top cover;
a bottom cover connected to the top cover, the housing being spaced apart under a liquid crystal panel;
chip-level LEDs disposed on a first surface of the bottom cover; and
molding portions disposed on the first surface and covering the LEDs, respectively.

11. The LED backlight unit of claim 10, wherein each of the molding portions comprises:
a first molding portion covering the LED; and
a second molding portion disposed on the first molding portion.

12. The LED backlight unit of claim 11, wherein a refractive index of the first molding portion is different from a refractive index of the second molding portion.

13. The LED backlight unit of claim 11, wherein:
each of the molding portions comprises a medium layer disposed between the first molding portion and the second molding portion; and
a refractive index of the medium layer being smaller than a refractive index of the first molding portion and a refractive index of the second molding portion.

14. The LED backlight unit of claim 13, wherein the medium layer comprises an air gap.

15. The LED backlight unit of claim 10, wherein the molding portion comprises a concave section in a center of a top surface.

16. The LED backlight unit of claim 10, wherein a plane shape of the molding portion is any one of an axially symmetric shape, a 90-degree rotationally symmetric shape, and a 180-degree rotationally symmetric shape with respect to a central axis line of the molding portion.

17. The LED backlight unit of claim 10, wherein electrode patterns are disposed on the first surface.

18. The LED backlight unit of claim 10, wherein the molding portion comprises a shape different from the resin material by semi-curing a resin material primarily molded in advance and pressurizing the primarily molded resin material.

19. The LED backlight unit of claim 10, wherein the molding unit is configured to diffuse light emitted from the LEDs.

20. An LED display device, comprising the LED backlight unit of claim 1, wherein:
the top cover comprises an opening or window;
the bottom cover is connected to the top cover to form a single box-shaped housing; and
the liquid crystal panel is spaced apart from the first surface within the housing and exposed through the opening or window.
